(19) United States
(12) Patent Application Publication
(10) Pub. No.: US 2014/0166043 A1
(43) Pub. Date: Jun. 19, 2014

(54) INTERPROXIMAL CLEANING TOOL AND METHOD OF MANUFACTURE

(71) Applicant: RANIR, LLC, Grand Rapids, MI (US)

(72) Inventor: Bryan J. Dishon, Grand Rapids, MI (US)

(73) Assignee: RANIR, LLC, Grand Rapids, MI (US)

(21) Appl. No.: 13/715,283

(22) Filed: Dec. 14, 2012

(51) Int. Cl. A61C 15/02

(52) U.S. Cl. CPC A61C 15/02
USPC 132/329; 264/160

(57) ABSTRACT

The present invention provides an interproximal cleaning tool including a handle that is cut from a first plastic material, and a pick molded over a portion of the handle. The pick may be precision injection molded over an extension portion of the handle from a plastic material different from the first plastic material. A method for manufacturing an interproximal cleaning tool includes the steps of: (a) providing a sheet of plastic material; (b) cutting a handle for the interproximal cleaning tool from the sheet, the handle being cut such that the handle includes a grip portion and an extension portion extending from the grip portion, the handle defining a width, wherein the width of the extension portion is narrower than the width of the grip portion; and (c) molding a plastic pick over the extension portion to form the interproximal cleaning tool.

### BACKGROUND OF THE INVENTION

The present invention relates to an interproximal cleaner, and to a process for the production of an interproximal cleaner.

Interproximal cleaning tools and brushes are well known and are believed to help remove plaque and prevent gum recession. Interproximal tools typically include a handle, and a narrow, elongated portion extending from the handle for insertion between a user's teeth.

One common type of interproximal cleaning tool is formed by twisting a U-shaped strand of wire about a plurality of bristles to retain the bristles therein. The ends of the bristles extend through the wire, thus creating an interproximal brush, wherein the elongated portion and bristles can be inserted between a user's teeth.

Another type of interproximal cleaning tool is shown in U.S. Pat. No. 6,158,444 to Weihrauch. The Weihrauch patent notes particular disadvantages with the above-noted twisted wire style of interproximal tool. In particular, Weihrauch notes that the bristles can become detached during use, which is found to be very unpleasant by the user. In addition, the addition of such bristles can make the elongated portion of the cleaner excessively thick. Weihrauch aims to overcome these disadvantages by providing an interproximal cleaner having an elongated, rod-like carrier made from a first plastics material, and a softer plastic material overmolded onto the rod-like material. The rod-like material is injection molded from the first plastic material, and the softer plastic material is injection molded over the rod-like material in a second molding step.

The Weihrauch cleaning tool also suffers from disadvantages. For instance, it may be difficult to injection mold a plastic rod-like material that is both (1) thin enough to comfortably fit between a user's teeth and (2) rigid enough to enable a user to extend between teeth without unwanted bending or flexing that would prevent the cleaner from complete insertion between the teeth. In addition, there are significant capital investments associated with two separate sets of injection molds and molding equipment for completing the two step molding process.

### SUMMARY OF THE INVENTION

The present invention provides an interproximal cleaning tool including a handle that is cut from a first plastic material, and a pick molded over a portion of the handle. In one embodiment, the plastic handle includes opposing grip surfaces capable of being gripped by a user, and may include a grip portion and an extension portion that is narrower than the grip portion. The handle, however, need not include opposing surfaces and need only be defined by the shape of the first plastic materials and the shape of the tool used to cut the handle from the first plastic material. The pick may be precision injection molded over the extension portion of the handle from a second plastic material different from the first plastic material; and the pick may include an interproximal portion and an attachment portion. The pick may also be created using alternative methods, such as the adhesion of a formed or unformed medium, dip coating and forming, and the application of adhesives which are then cured. The attachment portion of the pick overlies at least part of the extension portion of the handle. In one embodiment, the interproximal portion of the pick tapers to a distal tip for insertion between a user's teeth, and the interproximal portion of the pick may include a plurality of nubs integrally molded with the pick as a unitary piece.

The present invention further provides a method for manufacturing an interproximal cleaning tool, including the steps of: (a) providing a sheet of plastic material; (b) cutting a handle for the interproximal cleaning tool from the sheet, the handle being cut such that the handle includes a grip portion and an extension portion extending from the grip portion, the handle defining a width, wherein the width of the extension portion is narrower than the width of the grip portion; and (c) molding a plastic pick over the extension portion to form the interproximal cleaning tool. The handle portion may have a longitudinal length greater than its width at the grip.

In another embodiment, the present invention provides a method for manufacturing multiple interproximal cleaning tools, including the steps of: (a) providing a sheet of plastic material; (b) transporting the sheet of plastic material to a cutting station; (c) providing a die shaped for cutting multiple interproximal device handles at approximately the same time; (d) cutting multiple interproximal device handles from the sheet of plastic material with the die; (e) moving the interproximal device handles into a mold, the mold shaped to overmold multiple pick portions of the interproximal cleaning tools onto selected portions of the interproximal device handles; (f) overmolding the pick portions onto the selected portions of the handles in the mold, such that the selected portions of the handles extend into portions of the picks respectively; and (g) removing the interproximal cleaning tools having handle portions with overmolded pick portions from the mold.

The present invention provides an interproximal cleaning tool with a handle portion that is easily gripped by a user, and a pick portion that can be comfortably inserted between a user's teeth. The tool can be easily and efficiently manufactured by a single cutting step and a single molding operation. Various dimensions of the pick and the handle can be varied to control the stiffness of the pick and the handle, as well as the attachment between the pick and the handle.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and is capable of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### BRIEF DESCRIPTION OF THE DRAWINGS

FIG. 1 is a perspective view of an interproximal cleaning tool according to one embodiment of the present invention.

FIG. 2 is front view of the interproximal cleaning tool.

FIG. 3 is a side view thereof.

FIG. 4 is a side cross sectional view thereof taken along line A-A in FIG. 3.

FIG. 5 is a top view thereof.

FIG. 6 is a rear view thereof.

FIG. 7 is a close up top view of the pick portion of an interproximal cleaning tool according to one embodiment of the present invention.

FIG. 8 is diagram of a method for manufacturing an interproximal cleaning tool according to one embodiment of the present invention.

### DESCRIPTION OF THE CURRENT EMBODIMENT

I. Overview

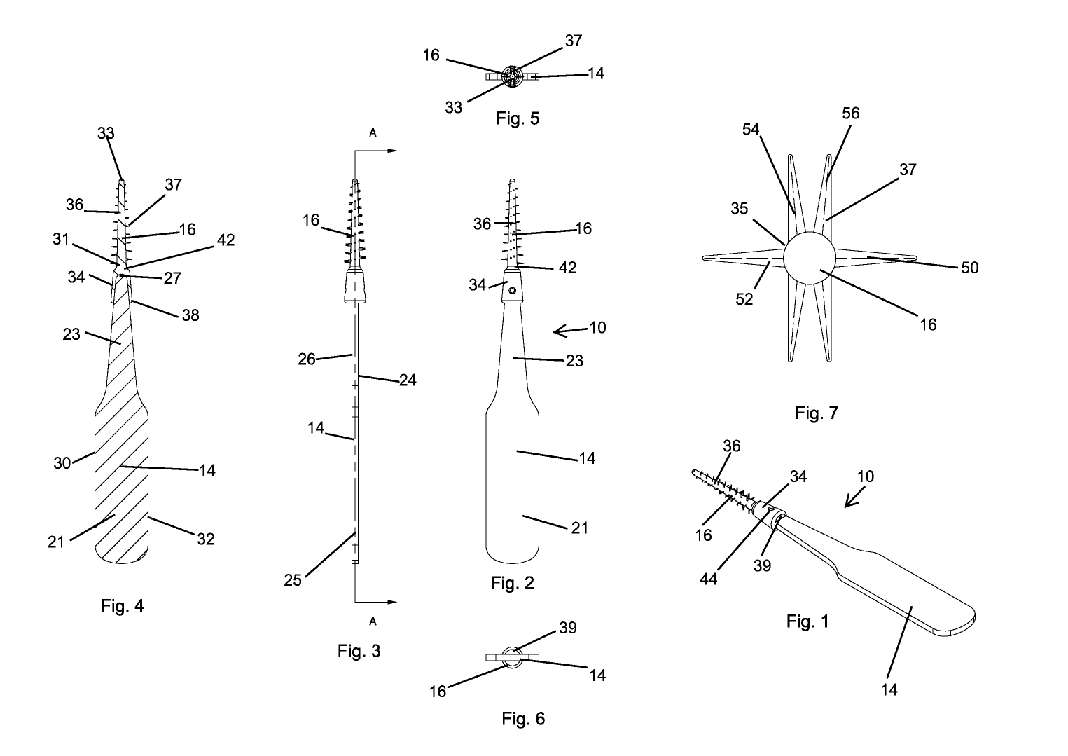

As shown in FIGS. 1-7, the present invention is directed to an interproximal cleaning tool that is generally designated 10. In one embodiment, interproximal cleaning tool 10 includes a handle member 14 and a pick member 16. The handle member 14 may be formed by providing a sheet of material 20 in a desired thickness, and cutting the handle member 14 from the sheet of material 20. The pick member 16 may be formed by molding the pick member 16 over at least a portion of the handle member 14. In one embodiment, the pick member may be formed to include a plurality of nubs 37 or protrusions extending therefrom.

II. Structure

The handle member 14 may be formed in any configuration adapted to be grasped by a user for manipulating the interproximal cleaning tool 10. In the illustrated embodiment, the handle 14 is elongated and generally flattened, which provides top and bottom surfaces 24, 26 adapted to be gripped between a user's thumb and forefinger. The handle 14 defines a thickness 25 between the top 24 and bottom 26 surfaces, which may vary from application to application depending on factors such as the desired amount of strength and flexibility of the cleaning tool 10. In one embodiment, the thickness 25 is between about 0.015″ and 0.125″. In another embodiment, the thickness 25 is about 0.03″. The entire handle portion 14 may have a uniform thickness. As shown, the handle 14 includes a widened grip portion 21 and a narrower extension portion 23 extending from the grip portion 21. The grip portion 21 defines a width between opposing sides 30 and 32. As with the thickness 25, the width may be varied from application to application. In one embodiment, the width is at least equal to the handle thickness 25, and in a more particular embodiment, the width is about 0.25″. In one embodiment, the extension portion 23 narrows continuously from the grip portion 21 to a distal end 27 as is shown, for example, in FIG. 4. This narrowing of the extension portion 23 provides a transition between the grip portion 23 and the pick 16, which is described in more detail below. As shown, the grip portion 21 extends about 47% of the length of the handle portion 14; however, the proportion of the grip portion length to the extension portion length may also vary, depending on the application. For instance, a more flexible cleaning tool 10 may have a shorter grip portion 21 and a relatively longer extension portion 23. The handle portion may also include a series of grip protrusions (not shown) extending from the grip portion 21 to increase the gripping surface and provide an aesthetically pleasing appearance.

In one embodiment, the handle member 14 is formed by cutting or otherwise removing the handle member 14 from a larger portion of material. For instance, the handle member 14 may be cut from a sheet of material 20 by die cutting or punching the handle member 14 from the sheet of material 20. The handle 14 may be cut from the sheet of material 20 into the desired shape by a single die cutting step or through multiple die cutting steps. In such an embodiment, the sheet of material may be provided with the desired thickness 25 of the cleaning tool 10, such that the single cutting step yields a cleaning tool 10 having the desired width and thickness 25. The handle 14 may be formed from a variety of materials, such as polypropylene, polystyrene, polyethylene, polyvinyl chloride (PVC), polyamide (PA), acrylonitrile butadiene styrene (ABS), or another relatively rigid plastic.

In one embodiment, the pick 16 is formed from a thermoplastic elastomer (TPE) that is softer than the material forming the handle 14. Examples of TPE's that may be used include styrenic block copolymers, polyolefin blends and polyurethanes. The materials used for both the handle 14 and pick 16 may be selected in combinations that will create a chemical bond between the handle 14 and pick 16 when the pick 16 is formed. For example, both the handle 14 and pick 16 materials may be styrenic compounds that form a bond when the pick 16 is molded onto the handle as described in more detail below. The pick 16 may also be formed from a more rigid thermoplastic material, including any of the materials noted above for forming the handle 14.

The pick 16 generally includes an attachment portion 34 and an interproximal portion 36. The attachment portion 34 interfits with the handle 14, particularly the extension portion 23 of the handle 14, and the interproximal portion 36 is designed to be inserted between a user's teeth. As illustrated, the attachment portion 34 is generally frustoconical in shape, including a lower end 38 defining an opening having a first diameter and an upper end 42 having a second diameter that is smaller than the first diameter. For example, the first diameter may be about 0.15″ and the second diameter may be about 0.12″. The change in diameter of the attachment portion 34 corresponds to the angle of taper on the extension portion 23 of the handle 14 to provide a tight fit between the attachment portion 34 and the extension portion 23.

The interproximal portion 36 of the pick portion 16 is generally conical in shape, although other shapes, such as a flat or triangular cross section, may also be used. The interproximal portion extends from a base 31 at the junction with the upper end 42 of the attachment portion 34 to a tip 33, such that the cross section of the interproximal portion 36 decreases from the base 31 to the tip 33, wherein the tip 33 is narrow and capable of insertion between a user's teeth. The size of the pick 16 may vary from application to application. In one embodiment, the base 31 of the pick 16 may have a diameter between about 0.08″ and 0.18″ and the tip 33 may have a diameter between about 0.02″ and 0.075″. In the illustrated embodiment, the base 31 has a diameter of about 0.1″ and the tip 33 has a diameter of about 0.02″. The length of the pick 16 may also vary, and in one embodiment the length is about 1.22″. Additionally, the proportional lengths of the attachment portion 34 and the interproximal portion 36 may be changed from application to application depending on the desired stiffness of the interproximal portion 36 (a shorter interproximal portion 36 increases stiffness and resists bending of the pick when inserted between a user's teeth) and the desired attachment force between the attachment portion 34 and the handle 14 (a longer attachment portion 34 provides increased contact between the pick 16 and handle 14 and thus increases the attachment force). In one embodiment, the attachment portion 34 has a length of about 0.35″ and the interproximal portion 36 has a length of about 0.85″, such that the length of the attachment portion 34 is about 40% of the length of the interproximal portion 36.

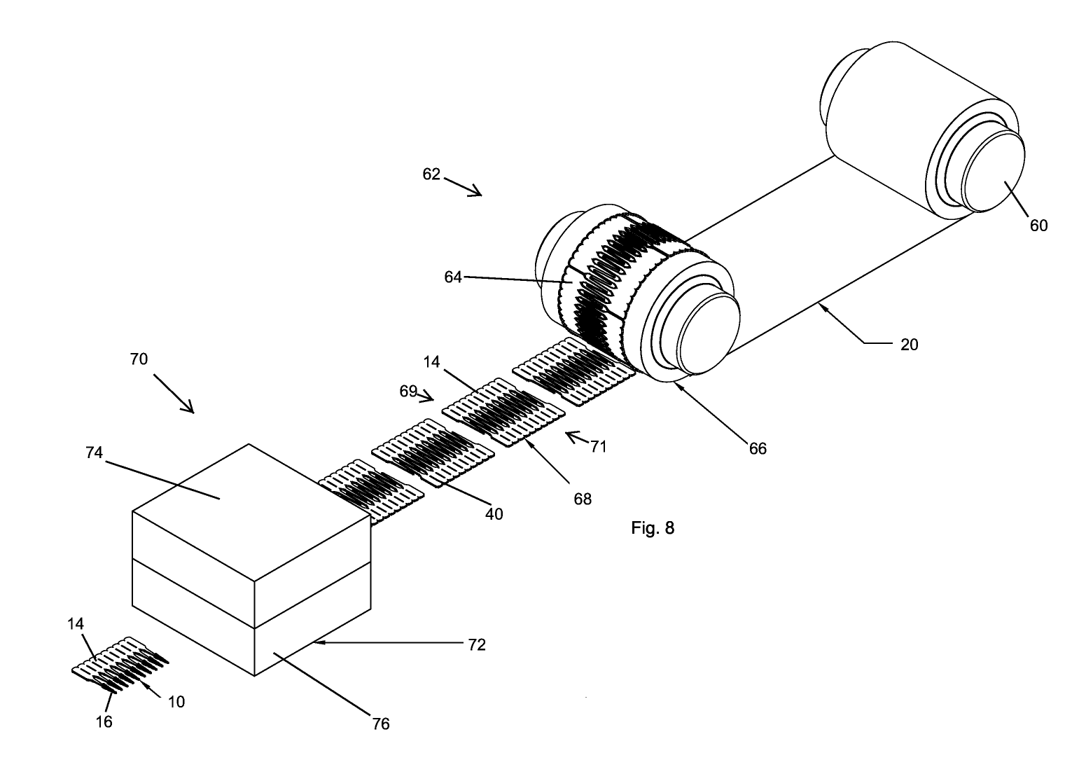

Referring to FIG. 7, the pick 16 includes a sidewall 35 that may include a plurality of nubs or protrusions 37 extending radially outwardly therefrom. The nubs 37 may act as a brush to pull unwanted materials from between the user's teeth. As shown, the nubs 37 are dispersed generally symmetrically on opposing sides of a vertical centerline 50, with a first pair of diametrically opposed nubs 52 extending along the centerline 50, and two additional pairs of diametrically opposed nubs 54, 56. In the illustrated embodiment, the nubs 54, 56 are spaced apart from each other at an angle α of approximately 10 degrees the sidewall 35. In another embodiment (not shown), nubs 54, 56 are spaced apart from each other at an angle α between 5 and 45 degrees. The nubs 37 may be spaced apart generally uniformly from the base 31 to the tip 33. Although the nubs 37 may have a variety of shapes, in the illustrated embodiment, the nubs 37 are conical. The length of the nubs 37 may also be varied, and may decrease approaching the tip 33 of the pick 16. For example, the length of the nubs 37 may be between about 0.010″ and 0.10″. In one embodiment, the nubs 37 near the base 31 of the pick are about 0.079″ in length and the nubs 37 near the tip 33 are about 0.016″ in length.

In an alternative embodiment, the nubs 37 may be formed from a material different form the material of the pick 16. For example, the protrusions may be filament strands that are placed directly into the mold that forms tool 10. In an embodiment in which tool 10 is formed by injection molding, the filament strands may be placed in the mold before the desired material is injected into the mold. After the material is injected, and as the material solidifies to form tool 10, the material solidifies around or about filament strands. Thus, filament strands are securely retained in the pick 16, and will not likely fall out during use or handling of the tool. Such filament strands may be formed from any suitable material adapted to gently clean the interproximal area and/or massage and stimulate gums to promote blood circulation and healthy gum tissue. For example, the filament strands may be formed from a soft multifilament yarn, such as multifilament polyethylene yarn, having a plurality of soft filament fibers twisted together. Alternatively, filament strands may be formed as monofilament polyethylene tape, which may create elongated or generally rectangular filament strand cross sections. Other suitable materials for filament strands include materials typically used for dental floss, such as nylon, ultra high molecular weight polyethylene (UHMWPE) and polytetrafluoroethylene (PTFE). In an embodiment in which filament strands are formed from polyethylene, the filament strands may have a denure of approximately 800. To ensure the softness of the filament strands, the filament strands may be formed from a material having a denure in the range of approximately 200-1350. When forming nubs 37 using an injection molding process, the desired softness may be obtained using materials with durometer hardness between about Shore A 30 and about Shore D 60.

As noted above, the pick 16 may be formed by overmolding the pick 16 onto a portion of the extension portion 23 of the handle 14. For example, the die cut handle 14 may be placed into an injection mold cavity for a molding operation that molds the pick 16 over the extension portion 23. In the illustrated embodiment, the pick 16 is molded to the extension portion 23 such that the attachment portion 34 overlaps a desired amount of the extension portion 23, and the base 31 of the pick 16 is adjacent to the distal end 27 of the handle 14 to enclose the distal end 27 of the handle 14. In one embodiment, the upper end 42 of the attachment portion 34 abuts the distal end 27 of the handle 14; however, the pick 16 may otherwise be formed such that there is a gap between the upper end 42 and the distal end 27 of the handle 14. In one embodiment, the attachment portion 34 of the pick 16 overlaps about 0.14″ of the length of the extension portion 23, which, in the illustrated embodiment, is about 20% of the total length of the extension portion 23 and about 7% of the overall length of the handle portion 14. Of course, the extent of this overlap may be varied to adjust the strength of the bond between the handle portion 14 and the pick portion 16. In one example, the length of the attachment portion is less than about 75% of the extension portion 23, and in another more particular example, the length of the attachment portion is less than about 50% of the length of the extension portion 23. As shown in FIG. 1, the diameter of the lower end 38 of the attachment portion 34 is greater than the thickness 25 of the handle 14. As a result, the attachment portion 34 may include fill regions 39 of the pick material to fill in any gaps between the sidewall of the attachment portion 34 and the surfaces 24, 26 of the handle 14 such that the attachment portion 34 engages the surfaces 24, 26 and can form a bond therebetween. In one embodiment, in order to create a pick which is safely secured to the handle portion, the pick may be attached with a pull off force of at least about 0.2 lbf when removed in a direction generally parallel to the longitudinal axis.

As shown, the handle 14 and the pick 16 may optionally include one or more holes 44 extending to the reinforcement member 12. The holes 44 may be formed as a result of the manufacturing process, wherein the mold includes mold parts that extend into contact with the extension portion 23 as the pick 16 is overmolded. The mold parts locate the pick 16 with respect to the handle 14, and retain the handle 14 in a fixed position as the pick 16 is molded.

III. Method of Manufacture

Manufacture of the present invention generally includes the steps of (a) providing a material to be formed into a handle; (b) forming the handle from the material by cutting a desired handle shape from the material; (c) placing the handle into a mold cavity; (d) molding a plastic pick over a portion of the handle such that the plastic pick overlaps a portion of the handle; and (e) removing the device from the mold cavity.

The material to be formed into a handle 14 may be provided in a number of different ways. For instance, the material may be provided in a sheet form having a thickness that is the desired thickness of the interproximal cleaning device 10. As shown in FIG. 8, the sheet 20 may be provided on a roller 60. In an alternative embodiment, the sheet may be extruded on site and fed directly to a die cutting station, or the sheet may be formed off site and delivered in a series of sheets or a roll form that can be fed to a die cutting station.

A die cutting station 62 according to one embodiment of the present invention is shown in FIG. 8. In this illustrated embodiment, the die cutting station includes a die 64 formed about the circumference of a roller 66. Although the die 64 may be shaped to form a single handle 14, the illustrated die 64 is shaped to form groups 68 of twenty handles 14, with the grip portions 21 of ten handles 14 in a first subgroup 69 being interconnected by thin bridge elements 40 of the sheet material and the grip portions 21 of ten handles 14 in a second subgroup 71 being similarly interconnected. It should be recognized that the groups of handles can be more or less than twenty handles. The bridge elements 40 may be formed by partially cutting portions of the sheet material 20 between of the grip portions 21 to leave thin bridge elements 40 connected between the grip portions 21. The extension portions 23 of each handle 14 are cut such that the extension portion 23 of each handle 14 in the first subgroup 69 interfits between the extension portions 23 of the handles 14 in the second subgroup 71 (with the exception of the outermost handles 14). The extension portions 23 of each handle 14; however, are not connected to or in contact with any portion of any other handle 14. Alternative methods for cutting the handles 14, or groups of handles, may otherwise be used. For instance, the handles 14 may be stamped from the sheet of material 20 in a press, or the handles 14 may be cut from the sheet of material by another known method.

In the illustrated embodiment, the groups 68 of handles 14 are transported to a molding station 70 by a conventional method. At the molding station 70, a group 68 of handles 14 may be placed into the cavity of a mold 72 between a first mold half 74 and a second mold half 76. The picks 16 may be overmolded onto the desired area of the extension portion 23 of each respective handle 14 within the mold 72. The molding step may be an injection molding step, such that the plastic material of the pick 16 is injected into the mold 72 over the respective portion of the handle member 14. In one embodiment, the molding step includes precision injection molding of the picks 16 over the handles 14. As noted above, the nubs 37 may be molded with integrally with the picks 16 as a single unitary piece. Additional details, such as grip surfaces or logos, may be formed on the handles 14 during the molding step. The step of placing the handle 14 (or group of handles 14) into the mold may include positioning the handles 14 in the mold cavity at a predetermined location such that the pick portions 16 extend a predetermined distance over the length of the handles 14.

As noted above, the materials of the handle 14 and pick 16 may be selected such that they form a chemical bond when the heated pick material is molded over the handle material. In one embodiment, this chemical bond may provide a sufficient connection between the handle and the pick to prevent unwanted detachment of the handle 14 and pick 16. In an alternative embodiment, other methods may be used to create a connection between the handle 14 and the pick 16. By way of example, an adhesive may be added to the handles 14 prior to the molding operation to create or assist in bonding the handle 14 and pick 16. In another embodiment, a mechanical connection may be created, for instance, by extending a pin or another fastener through the pick material and the handle material to assist or create an attachment therebetween. The pick 16, and any additional materials used for attachment between the pick 16 and the handle 14, are generally attached with a pull off force of at least about 0.2 lbf when removed in a direction generally parallel to the longitudinal axis.

The series of interconnected interproximal cleaning tools 10 may then be removed from the second mold. The bridge elements 40 may be broken apart—either by the manufacturer or the consumer—to separate the individual interproximal cleaning tools 10.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation(s).

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

The embodiments of the invention in which an exclusive property or privilege is claimed are defined as follows:

1. A method for manufacturing interproximal cleaning tools comprising:
(a) providing a sheet of plastic material;
(b) transporting the sheet of plastic material to a cutting station;
(c) providing a die shaped for cutting multiple interproximal device handles at approximately the same time;
(d) cutting multiple interproximal device handles from the sheet of plastic material with the die;
(e) moving the interproximal device handles into a mold, the mold shaped to overmold multiple pick portions of the interproximal cleaning tools onto selected portions of the interproximal device handles;
(f) overmolding the pick portions onto the selected portions of the handles in the mold, such that the selected portions of the handles extend into portions of the picks respectively, wherein a grip portion of each of the handles remains exposed; and
(g) removing the interproximal cleaning tools having handle portions with overmolded pick portions from the mold.

2. The method of claim 1 wherein the step of cutting the interproximal device handles includes cutting the handles to include a grip portion and an extension portion extending from the grip portion, wherein the extension portion is generally narrower than the grip portion.

3. The method of claim 2 wherein the step of cutting the interproximal device handles includes completely cutting a portion of the extension portions such that they are not connected to or in contact with any other handles, and partially cutting between the grip portions of the handles to leave thin bridge elements between the grip portions.

4. The method of claim 3 wherein the step of cutting the handles includes cutting the handles into groups of twenty handles, wherein ten of the handles in each group are interconnected by bridge elements to form a first subgroup and the other ten of the handles in each group are interconnected by bridge elements to form a second subgroup.

5. The method of claim 4 wherein the extension portions of the first subgroup are interfitted between, but not in contact with, the extension portions of the second subgroup.

6. The method of claim 1 wherein a chemical bond is formed between the handle material and the pick material during the molding step.

7. The method of claim 1 in wherein multiple cutting operations occur to form the final handle shape.

8. The method of claim 1 in wherein punch press die cutting is implemented to form the final handle shape.

9. The method of claim 1 in wherein laser cutting is implemented to form the final handle shape.

10. The method of claim 1 in wherein water jet cutting is implemented to form the final handle shape.

11. The method of claim 1 wherein the pick is molded from a thermoplastic rubber.

12. A method for manufacturing an interproximal cleaning tool comprising the steps of:
(a) providing a sheet of plastic material;
(b) cutting a handle for the interproximal cleaning tool from the sheet, the handle being cut such that the handle includes a grip portion and an extension portion extending from the grip portion, the handle defining a width, wherein the width of the extension portion is narrower than the width of the grip portion; and
(c) molding a plastic pick over the extension portion to form the interproximal cleaning tool.

13. The method of claim 12 wherein the plastic pick includes an attachment portion and an interproximal portion, and the extension portion of the handle includes a base adjacent the grip portion and a distal end opposite the base, the attachment portion of the pick being molded over a portion of the extension portion of the handle including the distal end of the handle.

14. The method of claim 13 wherein the attachment portion extends over less than about 75% of the extension portion.

15. The method of claim 14 wherein the attachment portion extends over less than about 50% of the extension portion.

16. The method of claim 13 wherein the handle is a single unitary piece that is cut in a single cutting step, and the cut handle is transported to a molding station, the pick overmolded onto the handle in the molding station.

17. The method of claim 13 wherein the length of the interproximal portion is approximately 40% of the length of the attachment portion.

18. The method of claim 12 wherein the pick is molded from a softer plastic material than the handle.

19. The method of claim 18 wherein the pick is molded from a thermoplastic elastomer.

20. An interproximal cleaning tool comprising:
a handle cut from a first plastic material, the plastic handle having opposing grip surfaces capable of being gripped by a user; and
a pick injection molded over a portion of the handle from a second plastic material different from the first plastic material, the pick including an interproximal portion and an attachment portion, that attachment portion of the pick overlying the portion of the handle, the interproximal portion of the pick tapering to a distal tip for insertion between a user's teeth, the interproximal portion of the pick having a sidewall including a plurality of nubs extending from the sidewall, the nubs integrally molded with the pick as a unitary piece.

21. The interproximal cleaning tool of claim 20 wherein the handle is cut to include a grip portion and an extension portion extending from the grip portion, the extension portion being narrower than the grip portion, the at least a part of the extension portion extending through the attachment portion of the handle.

22. The interproximal cleaning tool of claim 21 wherein the attachment portion overlies less than about 75% of the length of the extension portion of the handle.

23. The interproximal cleaning tool of claim 22 wherein the attachment portion overlies less than about 50% of the extension portion of the handle.

24. The interproximal cleaning tool of claim 21 wherein the attachment portion overlies less than about 25% of the length of the handle.

25. The interproximal cleaning tool of claim 20 wherein the nubs are spaced apart about the circumference of the pick such that the nubs are symmetrical with respect to a centerline extending through the pick.
